(19) United States
(12) Patent Application Publication
(10) Pub. No.: US 2017/0068512 A1
(43) Pub. Date: Mar. 9, 2017

(54) ELECTRONIC APPARATUS AND INFORMATION PROCESSING METHOD THEREOF

(71) Applicant: SAMSUNG ELECTRONICS CO., LTD., Suwon-si (KR)

(72) Inventors: Dae-woo CHO, Yongin-si (KR); Jong-jin PARK, Suwon-si (KR); Hyun-kyu YUN, Seoul (KR)

(21) Appl. No.: 15/048,099

(22) Filed: Feb. 19, 2016

(30) Foreign Application Priority Data
Sep. 9, 2015 (KR) 10-2015-0127691

(51) Int. Cl. G06F 3/16; G06F 3/0481; G06F 3/00

(52) U.S. Cl. CPC G06F 3/167; G06F 3/005; G06F 3/0481

(57) ABSTRACT

An electronic apparatus for processing conversation feature information between family members is provided. The electronic apparatus includes a storage configured to store conversation feature information of family members and a processor configured to determine whether conversations are made between the family members, based on at least one of a captured image acquired by capturing an image of a user and a user voice and to update the conversation feature information stored in the storage based on the determination result.

### CROSS-REFERENCE TO RELATED APPLICATION

This application is based on and claims priority under 35 U.S.C. §119 to Korean Patent Application No. 10-2015-0127691, filed on Sep. 9, 2015, in the Korean Intellectual Property Office, the disclosure of which is incorporated by reference herein in its entirety.

### BACKGROUND

Field

The disclosure relates generally to an electronic apparatus and an information processing method thereof, and for example, to an electronic apparatus that provides information about conversations between family members, and an information processing method thereof.

Description of Related Art

The development of electronic technologies has developed and distributed various types of electronic apparatus. Also, efforts to help family lives in a home by using such an electronic apparatus have been consistently made.

As one of electronic apparatuses developed by the efforts, an electronic apparatus that records, analyzes, and provides life patterns between family members has been used.

However, these types of electronic apparatus are deficient in providing functions of recording, analyzing, and providing information about conversations between family members.

Therefore, there is a need for an electronic apparatus that records and analyzes information about conversations between family members and provides the family members with various types of recording and analyzing results.

### SUMMARY

Example embodiments of the disclosure address the above disadvantages.

The disclosure provides an electronic apparatus for increasing conversations between family members, and an information processing method thereof.

According to an example aspect of the disclosure, an electronic apparatus includes a storage unit configured to store conversation feature information of family members, and a processor configured to determine whether conversations are made, based on at least one of a captured image acquired by capturing a user and a user voice and to update the conversation feature information stored in the storage unit based on the determination result.

The processor may be configured to acquire respective images and voices of the family members to generate family member information, to register the family member information in the storage unit, and, in response to at least one of the captured image and the user voice being input, to compare the at least one of the captured image and the user voice with the family member information to determine whether the conversations are made between the family members.

The processor may be configured to generate family member information based on an input pattern of the captured image and the user voice, to register the family member information in the storage unit, and, in response to at least one of the captured image and the user voice being input, to compare the at least one of the captured image and the user voice with the family member information to determine whether the conversations are made between the family members. The input pattern may include at least one selected from an input time zone, an input cycle, and an input frequency where the captured image and the user voice are respectively input.

The electronic apparatus may further include a display. In response to a preset event occurring, the processor may be configured to control the display to display the updated conversation feature information.

The electronic apparatus may further include an interface configured to be connected to a display apparatus. In response to a preset event occurring, the processor may be configured to transmit the updated conversation feature information to the display apparatus through the interface.

In response to a name of at least one of family members taking part in conversations, being detected from the user voice, the processor may be configured to determine that the conversations are made between the family members.

The conversation feature information may include a conversation time. In response to a determination being made that the conversations are made between the family members, the processor may be configured to add a time from a conversation start time to a conversation end time to an existing conversation time to update the conversation time.

The conversation feature information may include at least one selected from a conversation time, a current condition of one of the family members taking part in conversations, a conversation subject, a time zone where the conversations are made, and a conversation cycle.

The electronic apparatus may further include a camera configured to capture an image of the user to provide the captured image, and a microphone configured to receive the user voice.

According to another example aspect of the disclosure, a method of processing information of an electronic apparatus, includes determining whether conversations are made between family members, based on at least one of a captured image acquired by capturing a user and a user voice, and updating conversation feature information stored in a storage unit based on the determination result.

The method may further include acquiring respective images and voices of the family members to generate family member information and registering the family member information in the storage unit, and, in response to at least one of the captured image and the user voice being input, comparing the at least one of the captured image and the user voice with the family member information to determine whether conversations are made between the family members.

The method may further include generating family member information based on an input pattern of the captured image and the user voice and registering the family member information in the storage unit, and, in response to at least one of the captured image and the user voice being input, comparing the at least one of the captured image and the user voice with the family member information to determine whether the conversations are made between the family members. The input pattern may include at least one selected from an input time zone, an input cycle, and an input frequency where the captured image and the user voice are respectively input.

The method may further include, in response to a preset event occurring, controlling a display to display the updated conversation feature information.

The method may further include, in response to a preset event occurring, transmitting the updated conversation feature information to a display apparatus through an interface.

The method may further include, in response to a name of at least one of the family members being detected from the user voice, determining that the conversations are made between the family members.

The conversation feature information may include a conversation time. The method may further include, in response to a determination being made that the conversations are made between the family members, adding a time from a conversation start time to a conversation end time to an existing conversation time to update the conversation time.

The conversation feature information may include at least one selected from a conversation time, a current condition of one of the family members taking part in conversations, a conversation subject, a time zone where the conversations are made, and a conversation cycle.

According to various example embodiments of the disclosure as described above, an amount of conversations between family members may be checked and be used to increase conversations between the family members.

Additional and/or other aspects and advantages of the invention will be set forth in part in the description which follows and, in part, will be apparent from the description.

### BRIEF DESCRIPTION OF THE DRAWINGS

The above and/or other aspects of the disclosure will be more apparent from the following detailed description, taken in conjunction with the accompanying drawings, in which like reference numerals refer to like elements, and wherein:

FIG. 1 is a diagram illustrating an example electronic apparatus;

FIG. 2 is a block diagram illustrating an example electronic apparatus;

FIGS. 3A through 3D are diagrams illustrating an example process of registering information about family members in an electronic apparatus;

FIG. 4 is a flowchart illustrating an example process of updating conversation feature information;

FIG. 5 is a block diagram illustrating an example electronic apparatus that transmits data;

FIG. 6 is a diagram illustrating an example electronic apparatus that is a wall clock;

FIG. 7 is a diagram illustrating another example electronic apparatus that is a wall clock;

FIG. 8 is a block diagram illustrating an example configuration of an example electronic apparatus; and

FIG. 9 is a flowchart illustrating an example information processing method of an electronic apparatus.

### DETAILED DESCRIPTION

Certain example embodiments of the disclosure will now be described in greater detail with reference to the accompanying drawings.

In the following description, like drawing reference numerals are used for the same elements even in different drawings. The matters defined in the description, such as detailed construction and elements, are provided to assist in understanding of the disclosure. Thus, it is apparent that the example embodiments may be carried out without those specifically defined matters. Also, well-known functions or constructions are not described in detail since they might obscure the disclosure with unnecessary detail.

The terms used herein are selected as general terms that are currently widely used in consideration of their functions in the disclosure. However, this may depend on intentions of those skilled in the art, precedents, emergences of new technologies, or the like. Also, terms may be arbitrarily selected in a particular case, and detailed meanings of the terms may be described in parts of example embodiments corresponding to the particular case. Therefore, the terms used herein may be defined based on meanings of the terms and whole contents of the example embodiments, and not necessarily on simple names of the terms.

Also, the same reference numerals or symbols described in the attached drawings may denote parts or elements that may perform the same functions. For convenience and to aid in understanding, the same reference numerals or symbols are used and described in different example embodiments. For example, although elements having the same reference numerals are all illustrated in a plurality of drawings, the plurality of drawings do not necessarily refer to any one example embodiment.

The singular expression also includes the plural meaning as long as it is consistent in the context. In the disclosure, the terms “include” and “comprise” designate the presence of features, numbers, steps, operations, components, elements, or a combination thereof that are written in the disclosure, but do not exclude the presence or possibility of addition of one or more other features, numbers, steps, operations, components, elements, or a combination thereof.

In the example embodiments of the disclosure, a “module” or a “unit” performs at least one function or operation, and may be implemented with hardware, hardware circuitry, firmware, software, or a combination thereof. In addition, a plurality of “modules” or a plurality of “units” may be integrated into at least one module except for a “module” or a “unit” which has to be implemented with specific hardware, and may be implemented with at least one processor (not shown).

When any part is connected to another part, this includes a direct connection and an indirect connection through another medium. Unless otherwise defined, when any part includes any element, it may be the case that any part may further include other elements without excluding other elements.

A processor may refer, for example, to an element that is configured to control a device and may be used with a central processing unit (CPU), a microprocessor, a controller, or the like. The processor may also be realized as a system-on-a-chip or System on chip (SOC or SoC) that may control an overall operation of the device. The processor may include processing circuitry, including one or more cores, configured to provide various functions and control.

In certain instances, detailed descriptions of related well-known functions or elements may be omitted or abbreviated to avoid unnecessarily complicating the disclosure.

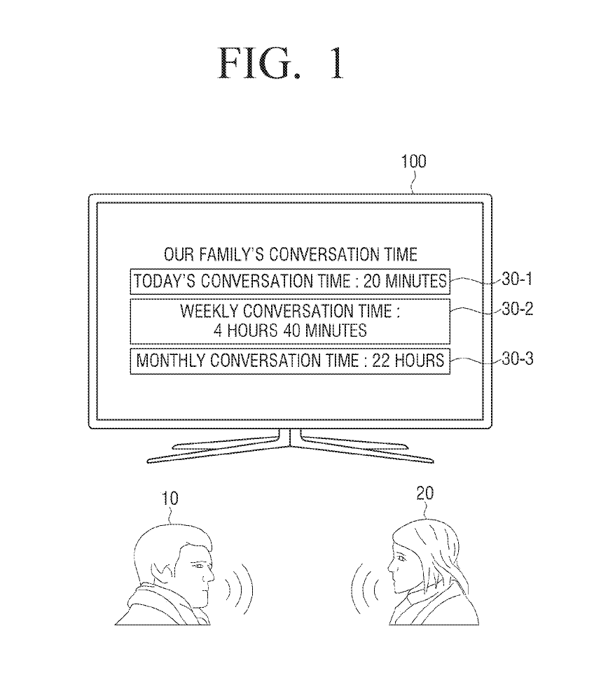

FIG. 1 is a diagram illustrating an example electronic apparatus 100 according to an example embodiment.

FIG. 1 illustrates the electronic apparatus 100 as including, for example, a display apparatus. The display apparatus 100 may display feature information about a conversation time between family members 10 and 20 using data about conversations between the family members 10 and 20. For example, the data about the conversations may be voices of the family members 10 and 20 or images acquired by capturing images of the family members 10 and 20. As illustrated in FIG. 1, conversation feature information may include, for example, a daily conversation time 30-1, a weekly conversation time 30-2, and a monthly conversation time 30-3 displayed on the display apparatus 100.

Voice data or captured image data of the family members 10 and 20 may be generated by a microphone (not shown) or a camera (not shown) installed in the electronic apparatus 100 or may be generated by a microphone (not shown) or a camera (not shown) separately installed outside the electronic apparatus 100.

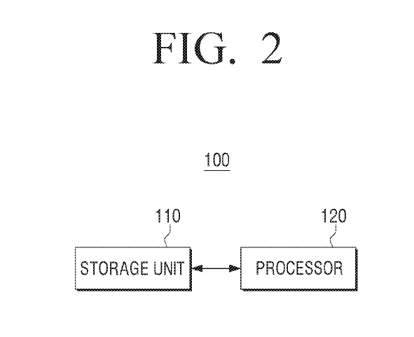

FIG. 2 is a block diagram illustrating an example electronic apparatus 100 according to an example embodiment.

Referring to FIG. 2, the electronic apparatus 100 may include, for example, a storage unit (e.g., including storage circuitry) 110 and a processor (e.g., including processing circuitry) 120.

The storage unit 110 stores information including, for example, various types of programs or data necessary for operating the electronic apparatus 100. For example, the storage unit 110 may store conversation feature information between family members. For example, if the processor 120 transmits feature information extracted from at least one of a captured image of a user and a user voice, the storage unit 110 may be configured to classify and stores the transmitted feature information under the control of, for example, the processor 120. For example, the feature information may be at least one selected from a conversation time, a current condition of one of the family members taking part in conversations, a conversation subject, a time zone where the conversations are made, and a conversation cycle.

The processor 120 may be configured to determine whether conversations are made between the family members, based on at least one of the captured image of the user and the user voice.

For example, the processor 120 may be configured to acquire family member information from the family members directly (e.g., input by a user) or may generate family member information through captured images or voices of the family members acquired, for example, in everyday lives of the family members.

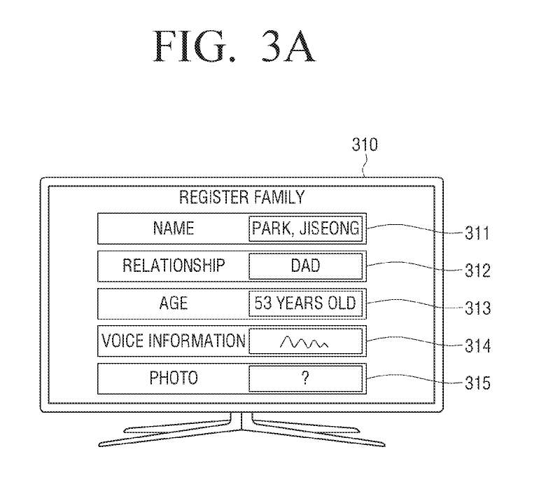

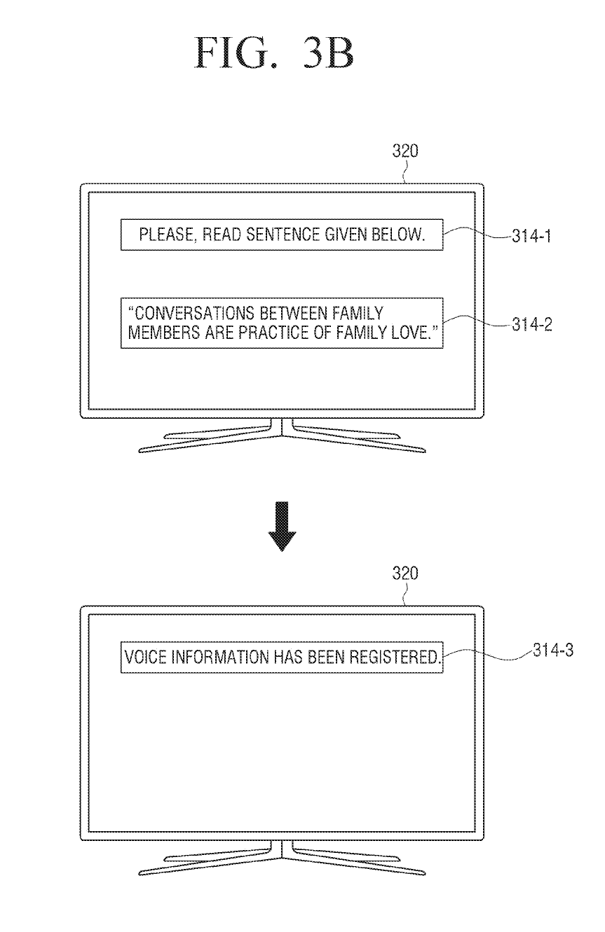

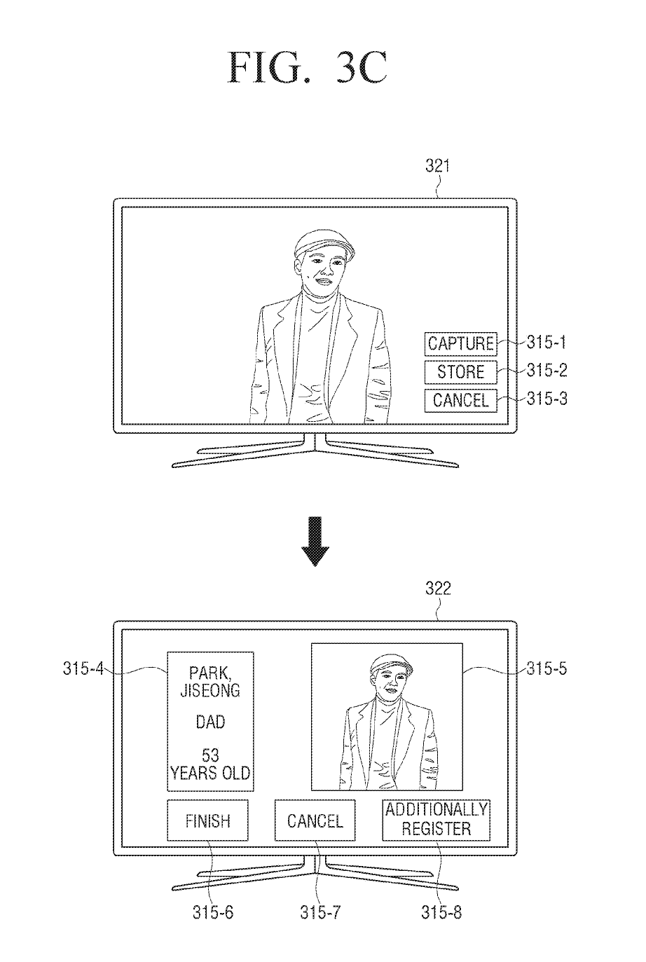

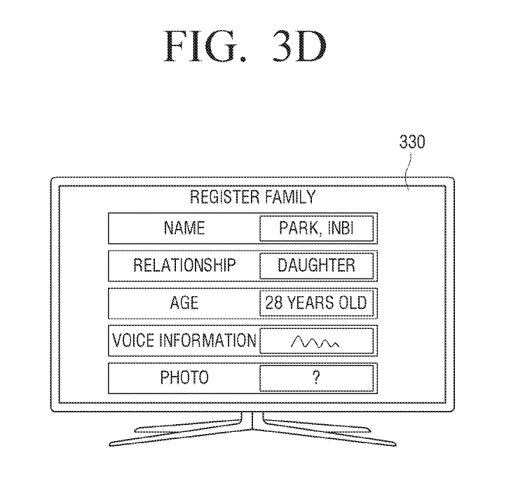

For example, the processor 120 may be configured to acquire respective images and voices of the family members to generate family member information and to register the family member information in the storage unit 110. This will be described in greater detail below with reference to FIGS. 3A through 3D.

FIGS. 3A through 3D are diagrams illustrating an example process of registering family member information in the electronic apparatus 100, according to an example embodiment.

Referring to FIG. 3A, the family member information may be displayed on a display 310 of the electronic apparatus 100, and may include, for example, a name 311, a relationship 312, an age 313, voice information 314, and a photo 315. For example, individual pieces of the family member information may be input based on orders or differently from the orders.

FIG. 3B illustrates a display 320 of the electronic apparatus 100 when, for example, voice information 314 is input. For example, if an icon of the voice information 314 (FIG. 3A) is selected, the processor 120 may be configured to display a guide sentence “Read a sentence given below, please.” on the display 320. For example, if a user reads “Conversations between family members are a practice of family love.” aloud, the processor 120 may be configured to extract voice feature information (or voice information) from a voice of the user and to store the voice feature information in the storage unit 110.

For example, the voice feature information may include information for distinguishing voices of individual family members. A voice may be a sound coming from a human, i.e., air coming from a lung is adjusted through a space such as a vocal cord of a throat, a mouth, a nose, or the like to generate the voice. For example, air produces sounds having various vibrations through a vocal cord, and the sounds are collected to generate unique voices of humans. Therefore, sounds respectively having different vibration frequencies constituting voices may be analyzed to distinguish humans from one another based on the voices. This may be referred to as a voiceprint. A technology for distinguishing humans by using voiceprints is variously well known, and thus a detailed description thereof is omitted.

If the above-described voice feature information is extracted and stored, the processor 120 may be configured to display an icon 314-3 including “Voice information has been registered”.

FIG. 3C is a diagram illustrating an example face photo of a user that is captured. If the user selects a photo item 315 (FIG. 3A), the processor 120 may be configured to change a mode into a photo capturing mode. For example, the user may select a capture icon 315-1 to capture an image of the user. In this example, the user may select a store icon 315-2 to store the captured image or may select a cancel icon 315-3 to cancel storing of the captured image. If family member information input is completed, the processor 120 may be configured to display an icon 315-4 including the input name, relationship, and age information, an icon 315-5 including a photo of the user, a finish icon 315-6, a cancel icon 315-7, and an additionally register icon 315-8 on a display 322. For example, the user may select the finish icon 315-6 to end a family member information input mode or may select the cancel icon 315-7 to delete currently input family member information of the user. If the additionally register icon 315-8 is selected, Referring to FIG. 3D, family member information (330) of another family member may be additionally input.

As described above, the processor 120 may be configured to acquire a captured image and/or a voice from a family member directly to generate family member information. However, the processor 120 may be configured to generate family member information based on an input pattern of a captured image acquired in an everyday life of the family member and a user voice without the user's knowledge and to register the family member information in the storage unit 110. For example, the input pattern may include at least one selected from an input time zone, an input cycle, and an input frequency where a captured image and a user voice are respectively input. The family member information may include, for example, name, relationship, voice, and face information.

The processor 120 may be configured to determine a family member using, for example, the input pattern of the captured image and the user voice.

For example, if an image and a voice of a user are periodically captured from 7 o'clock to 9 o'clock or from 19 o'clock to 24 o'clock each day on weekdays, the processor 120 may be configured to determine the corresponding user as a family member. If the number of times or a frequency the image and the voice of the user being input is higher than or equal to a preset value, the processor 120 may be configured to determine the corresponding user as a family member.

If the processor 120 determines that the captured information is that of a family member, the processor 120 may be configured to recognize a name of the family member and store voice information of a user corresponding to the name.

For example, the processor 120 may be configured to capture or receive a voice of the family member and to convert the voice into a text. For example, the processor 120 may be configured to convert the voice of the user into the text using an Automatic Speech Recognition (ASR) module or a Speech to Text (STT) module stored in the storage unit 110.

The processor 120 may be configured to determine a name and a voice of the family member by using the converted text. For example, if a second user responds to a particular word uttered by a first user, the processor 120 may be configured to determine the particular word uttered by the first user as a name of the second user. The processor 120 may also be configured to extract voice information from a voice of the second user who responds to the particular word uttered by the first user to store one of the name and the voice of the second user as family member information. For example, if the second user gives an answer “Yes, I am here, mom.” after the first user utters “Park, Inbi”. The processor 120 may be configured to determine “Park, Inbi” as the name of the second user and extract voice information from “Yes, I am here, mom.” uttered by the second user to store the voice information along with the name of the second user.

For example, if the number of times a particular word being uttered is higher than or equal to a preset number, the processor 120 may be configured to further add a condition where an intensity of the uttered particular word is higher than or equal to a preset intensity, or the like in order to increase an accuracy of a determination of a user name.

A relationship of a family member may be determined based on a similar example method to the above-described method. For example, a word indicating a family relationship such as “dad”, “mom”, “daughter”, “son”, or the like may be pre-stored. If a fourth user utters “Yes, which channel do you want to change into?” after a third user utters “Dad, change a TV channel, please.”, the processor 120 may be configured to recognize “dad” as a voice and determine a relationship of the fourth user responding to this as “dad”. The processor 120 may be configured to extract voice information from the utterance of the fourth user and store the voice information as voice information of “dad”.

The processor 120 may also be configured to extract face feature information (or face information) of a user from a captured image of the user. The processor 120 may be configured to distinguish a face of the user using the face feature information. For example, if the processor 120 extracts a mouth of a face of the user to recognize changes in a shape of the mount, the processor 120 may be configured to determine that the user is making conversations. For example, the processor 120 may be configured to match the face information of the user with the voice information extracted from the voice of the user input along with an image. A method of extracting face information will be described in greater detail in a method of determining conversations between family members, wherein the method of determining the conversations will be described below.

The processor 120 may be configured to accumulate voice information and face information described above for a preset period to generate family member information. For example, if a name and voice information of one of family members are generated, the processor 120 may be configured to determine a relationship and face information from a voice and an image that are input later, using the generated voice information. A name, a relationship, voice information, and face information of one of family members may be generated, for example, as one set.

If at least one of a captured image and a user voice is input, the processor 120 may be configured to compare the at least one of the captured image and the user voice with family member information to determine whether conversations are made between family members.

The processor 120 may be configured to determine whether conversations are made between family members, using a user voice.

For example, if a plurality of users utter voices, the processor 120 may be configured to extract voice information from each of the voices respectively uttered by the plurality of users. The processor 120 may be configured to compare the voice information of each of the plurality of users with pre-stored voice information to determine whether the plurality of users are respectively family members. For example, if the plurality of users are respectively the family members, the processor 120 may be configured to determine a situation where the voices are uttered by the plurality of users as a situation where conversations are made between the family members.

The processor 120 may be configured to determine whether the conversations are made between the family members, using an image of a user. For this, the processor 120 may be configured to extract face feature information from the image of the user.

For example, the processor 120 may be configured to perform a face recognition function with respect to the image to extract the face feature information of the user included in the image. For example, the face recognition function may include a process of detecting a face from the image and a process of recognizing feature data of the face.

For example, the processor 120 may be configured to detect the face from the image by using skin color information of the face. For example, the processor 120 may be configured to extract a feature point included in the face, e.g., an eye, a nose, a mouth, or the like, using a feature of a whole area of a face pattern or a geometrical feature of the face to recognize the face of the user. The processor 120 may also be configured to extract face feature information of the user included in the image based on the face recognition result. For example, the face feature information may include a face angle, a face pose, a face position, a proximity between faces, a face expression, etc.

For example, the processor 120 may be configured to determine the face angle and the face pose of the user included in the image.

For example, the processor 120 may be configured to detect feature points, such as an eye, a nose, a mouth, etc. from the face of the user included in the image and compare the detected feature points with feature points of a pre-stored standard face image (for example, a face set having a natural symmetry and a statistical symmetry of a face). The processor 120 may also be configured to determine a deviation between a capturing angle when capturing a face image and a capturing angle when capturing a standard image and determine a face angle by using the determined deviation.

The processor 120 may be configured to analyze the face angle and a direction, or the like, of eyes extracted in a face recognition process to determine the face pose of the user. For example, the face pose may be a face pose that is oblique, a face pose that faces upwards, or the like.

The processor 120 may be configured to determine a position of the face of the user included in the image and the proximity between the faces.

For example, the processor 120 may be configured to determine the position of the face from the image using the feature points of the eye, the nose, the mouth, etc. extracted in the face recognition process as reference coordinates. The processor 120 may also be configured to determine the proximity between the faces of the user based on the detected position of the face.

The processor 120 may be configured to determine the face expression based on sizes, shapes, etc. of the feature points included in the face.

For example, the processor 120 may be configured to determine an expression of the user through changes in a ratio between a pupil and a white of the eye based on sizes and shapes of the eye and the mouth extracted in the face recognition process and changes in a rising degree of a mouth corner and an area of the mouth. Examples of an expression recognition technology may include a method using edge information, an approach method based on luminance, chrominance, and geometrical appearance and symmetry of a face, a Principal Component Analysis (PCA), a method using template matching, an approach method using a curvature of a face, a method using a nerve network, etc.

A method of recognizing a face from an image and extracting face feature information from the recognized face has been described above, but this is only an example embodiment. The processor 120 may be configured to recognize a face and extract face feature information using any existing well-known various methods.

The processor 120 may be configured to determine whether conversations are made, using feature information extracted from an image of a user, i.e., a face angle, a face pose, a face position, a proximity between faces, a face expression, etc.

For example, the processor 120 may be configured to recognize a fifth user and a sixth user from a captured image. If it is determined that face angles and face poses of the fifth and sixth users are face angles and face poses at which faces of the fifth and sixth users face each other, and mouth shapes respectively extracted from faces of the fifth and sixth users are changed, the processor 120 may be configured to determine that the fifth and sixth users make conversations.

The processor 120 may be configured to determine whether a face proximity between the fifth and sixth users is higher than or equal to a preset value and whether face expressions of the fifth and sixth users are changed, as conditions for determining whether conversations are made between the fifth and sixth users.

The processor 120 may also be configured to determine whether the conversations are made between the fifth and sixth users, by using utterance times of voices of the fifth and sixth users and a sync of times for extracting face information of the fifth and sixth users appearing in an image. For example, if face angles of the fifth and sixth users are changed to an angle at which the fifth and sixth users face each other, and voice information of the fifth and sixth users are input at about the same time, the processor 120 may be configured to determine that the fifth and sixth users are making conversations.

If a name of at least one of family members is detected from a user voice, the processor 120 may be configured to determine that conversations are made between the family members. For example, if a seventh user calls a name of an eighth user, the processor 120 may be configured to determine that conversations are made between family members.

The processor 120 may be configured to update conversation feature information stored in the storage unit 110 based on the determination result. For example, the conversation feature information may be at least one selected from a conversation time, a current condition of one of family members taking part in conversations, a conversation subject, a time zone where conversations are made, and a conversation cycle.

For example, if it is determined that conversations are made between the family members, the processor 120 may be configured to add a time from a conversation start time to a conversation end time to an existing conversation time to update the conversation time.

The processor 120 may be configured to determine a family member taking part in conversations, using voice information extracted based family member information. For example, the processor 120 may be configured to match a time zone where conversations are made and a period where conversations are made, with some of family members to determine the family members. The processor 120 may be configured to update the current condition of the one of the family members taking in part in conversations, the time zone where the conversations are made, and the conversation cycle.

The processor 120 may be configured to determine a word, which frequently appears in conversations, as a conversation subject using a voice recognition function. The processor 120 may be configured to update a frequency of the determined conversation subject based on conversation subjects. For example, if “health” appears the preset number of times or more in conversations between family members, the processor 120 may be configured to determine a conversation subject as “health” or “exercise”. For example, the processor 120 may update “health” and “exercise” as conversation subjects.

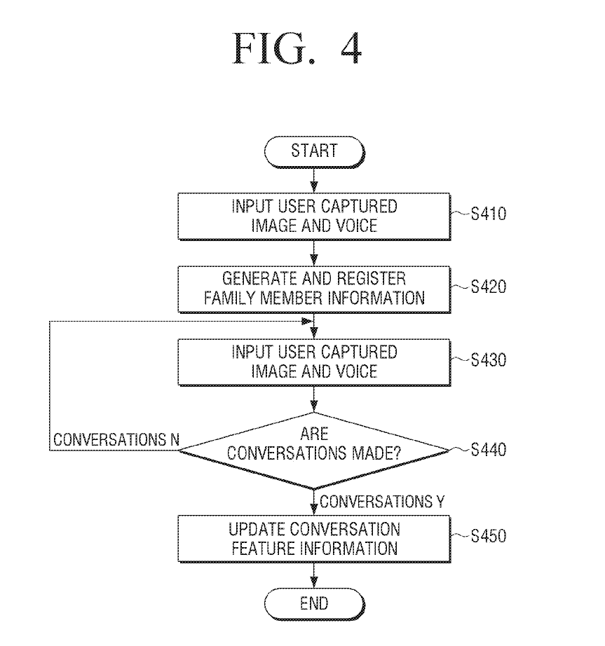

FIG. 4 is a flowchart illustrating an example process of updating conversation feature information according to an example embodiment.

Referring to FIG. 4, if a user captured image and a user voice are input in operation S410, the processor 120 generates and registers family member information using the user captured image and the user voice in operation S420. If the user captured image and the user voice are input after the family member information is generated in operation S430, the processor 120 determines whether conversations are made between family members in operation S440. If it is determined in operation S440 that the conversations are not made between the family members, the processor 120 returns to operation S430 to input the user captured image and the user voice. If it is determined in operation S440 that the conversations are made between the family members, the processor 120 extracts conversation feature information from the user captured image and the user voice and update conversation feature information in operation S450.

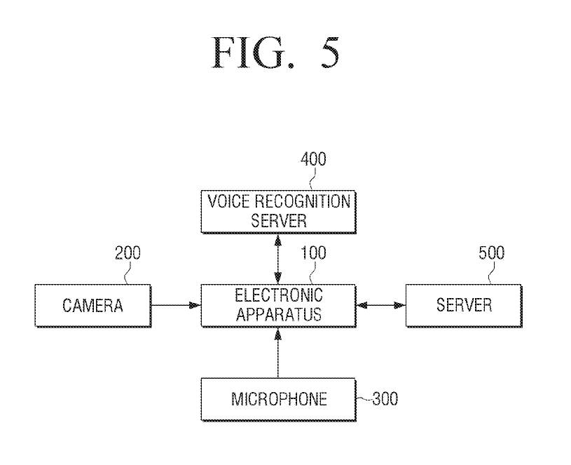

FIG. 5 is a block diagram illustrating an example electronic apparatus 100 that transmits data, according to an example embodiment.

Referring to FIG. 5, the electronic apparatus 100 may, for example, receive user captured image data from a camera 200 installed outside the electronic apparatus 100 and receive user voice information from a microphone 300 installed outside the electronic apparatus 100. The electronic apparatus 100 may, for example, also transmit voice data to a voice recognition server 400 installed outside the electronic apparatus 100 and receive text data corresponding to voice data from the voice recognition server 400. The electronic apparatus 100 may, for example, transmit conversation feature information to an external server 500 to update conversation feature information and receive stored feature information from the external server 500.

The electronic apparatus 100 may further include an interface (not shown) that may be connected to a display apparatus. For example, if a preset event occurs, the processor 120 may be configured to transmit the updated conversation feature information to the display apparatus (not shown) through the interface (not shown). For example, the preset event may correspond to turning on of the electronic apparatus 100 or the display apparatus, a preset time that arrives, starting or ending of a preset cycle, sensing of conversations between family members, not-sensing of conversations between family members for a preset time, or the like.

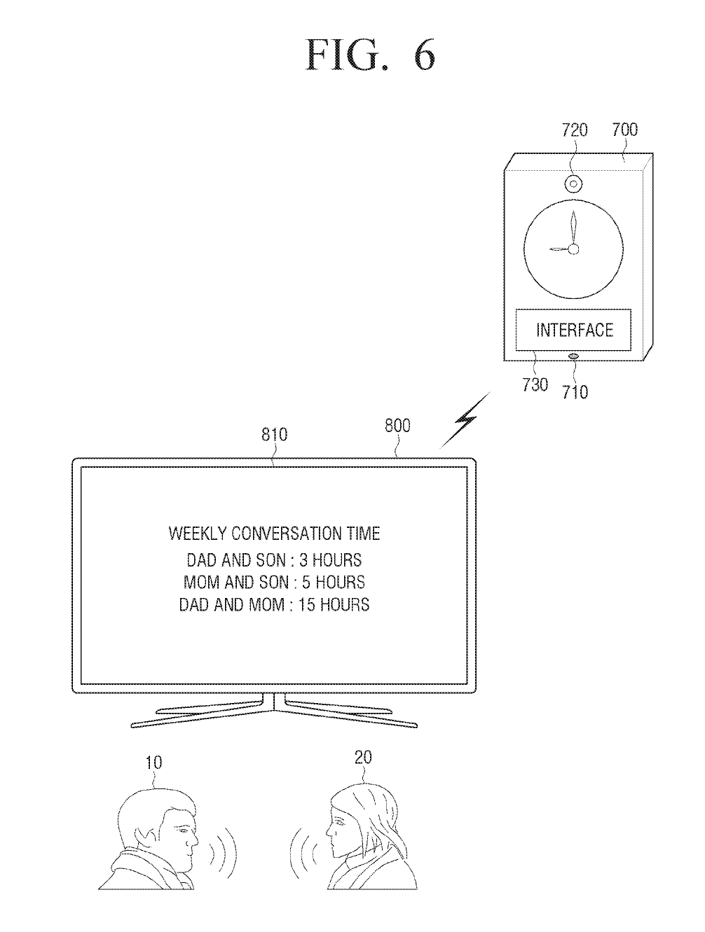

This will now be described in greater detail below with reference to FIG. 6.

FIG. 6 is a diagram illustrating an example electronic apparatus 100 that is a wall clock 700, according to an example embodiment.

Referring to FIG. 6, the wall clock 700 may include, for example, a microphone 710 that receives a user voice, a camera 720 that captures an image of a user to provide a captured image, and an interface 730 that exchanges data with an external device.

The wall clock 700 may, for example, receive a voice and an image of a user, who makes conversations, from the microphone 710 and the camera 720, respectively. The wall clock 700 may, for example, generate conversation feature information based on the received voice and image of the user. For example, the wall clock 700 may transmit the generated conversation feature information to an external display apparatus 800 using an interface 730 for wire and wireless communications.

For example, the display apparatus 800 that receives data about the conversation feature information from the wall clock 700 may display a Graphic User Interface (GUI) 810 for displaying weekly conversation times of family members. For example, the corresponding GUI 810 may be generated by a GUI generator (not shown) included in the wall clock 700 or a display 700.

The electronic apparatus 100 may further include a display (not shown), and the processor 120 may be configured to control the display (not shown) to display updated conversation feature information if a preset event occurs. For example, the preset event may correspond to turning on of the electronic apparatus 100, a preset time that arrives, starting or ending of a preset cycle, sensing of conversations between family members, not-sensing of conversations between the family members for a preset time, or the like.

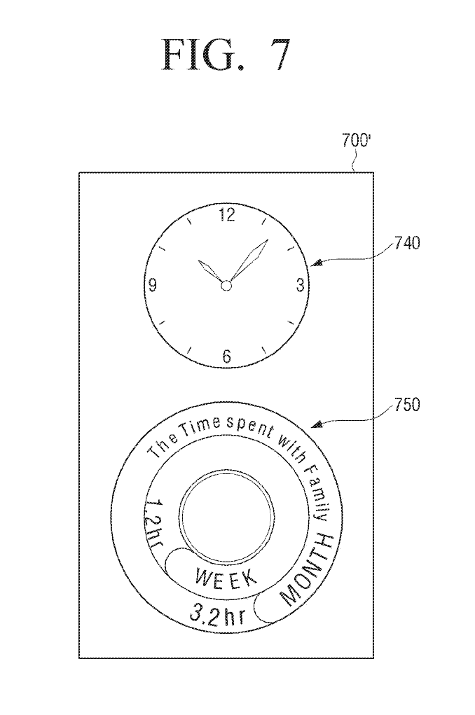

FIG. 7 illustrates an example electronic apparatus 100 that is a wall clock 700′, according to another example embodiment.

Referring to FIG. 7, the wall clock 700′ may include a clock 740 and a display 750. The clock 740 may refer, for example, to a general clock and may be realized as an analog or digital clock. The display 750 may be configured to display family conversation times on a weekly basis and on a monthly basis. For example, arrangements of the clock 740 and the display 750 may be made through various combinations.

For example, the wall clock 700′ has been described as an example embodiment of the electronic apparatus 100 but is not limited thereto. For example, the electronic apparatus 100 may be realized as various types such as a TV, a monitor, a PC, a portable phone, a tablet PC, a personal digital assistant (PDA), various types of wearable devices, etc.

According to an example embodiment, the processor 120 may be configured to automatically update conversation feature information for a schedule management program additionally installed in the electronic apparatus 100. For example, the processor 120 may be configured to update daily, weekly, and monthly conversation times in a schedule management program or, if a conversation time is shorter than a preset reference value, may insert a conversation request sentence into the schedule management program. For example, if a weekly conversation time is shorter than 10 hours, the processor 120 may be configured to automatically insert “Conversations between family members lack.” into a next Monday's schedule of a corresponding week.

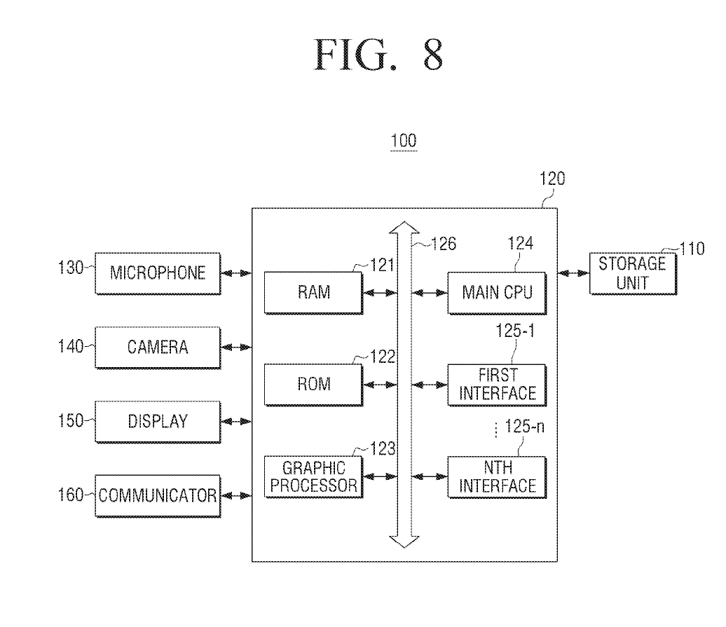

FIG. 8 is a block diagram illustrating an example configuration of an electronic apparatus 100, according to an example embodiment. Repeated detailed descriptions of the same elements of FIG. 8 as those of FIG. 2 are omitted. Some of the elements of FIG. 8 may be omitted or changed, or other elements may added.

A storage unit 110 may store data and a program for driving the electronic apparatus 100.

For example, the storage unit 110 may store family member information of each of family members. If a processor 120 generates conversation feature information and transmits the conversation feature information to the storage unit 110, the storage unit 110 may classify and store the conversation feature information into a current condition of one of the family members taking part in conversations, a conversation subject, a time zone where conversations are made, a conversation cycle, etc.

The storage unit 110 may store an operating system (O/S) software module for driving the electronic apparatus 100, various types of applications, various types of data input or set when executing an application, and various types of data such as contents, etc.

For example, the storage unit 110 may store a base module (not shown) that processes signals respectively transmitted from pieces of hardware included in the electronic apparatus 100 and transmits the processed signals to an upper layer module, a communication module (not shown) that performs various communications, etc.

The processor 120 may be configured to control an overall operation of the electronic apparatus 100 using various types of programs stored in the storage unit 110.

For example, the processor 120 may be configured to execute an application stored in the storage unit 110 to configure and display an execution screen of the application and may play various types of contents stored in the storage unit 110. The processor 120 may also be configured to perform communications with external devices through a communicator (e.g., including communication circuitry) 160.

For example, the processor 120 may include a random access memory (RAM) 121, a read only memory (ROM) 122, a graphic processor 123, a main central processing unit (CPU) 124, first through n^{th} interfaces 125-1 through 125-n, and a bus 126.

The RAM 121, the ROM 122, the graphic processor 123, the main CPU 124, and the first through n^{th} interfaces 125-1 through 125-n may be connected to or communicate with one another through the bus 126.

The first through n^{th} interfaces 125-1 through n^{th} interfaces 125-1 through 125-n may be connected to various types of elements described above. One of the first through n^{th} interfaces 125-1 through 125-n may be a network interface that is connected to an external apparatus through a network.

The main CPU 124 accesses the storage unit 110 to perform booting by using an O/S stored in the storage unit 110. The main CPU 124 may also perform various types of operations by using various types of programs, contents, data, etc. stored in the storage unit 110.

The ROM 122 stores a command set, etc. for booting a system. If power is supplied through an input of a turn-on command, the main CPU 124 copies the O/S stored in the storage unit 110 into the RAM 121 according to a command stored in the ROM 122 and executes the O/S to boot the system. If the system is completely booted, the main CPU 124 copies various types of application programs stored in the storage unit 110 into the RAM 121 and executes the application programs copied into the RAM 121 to perform various types of operations.

The graphic processor 123 generates a screen including various types of objects such as an icon, an image, a text, etc. by using an operator (not shown) and a renderer (not shown). The operator calculates attribute values, such as coordinate values at which objects are to be displayed, sizes, colors, etc. of the objects, etc. according to a layout of the screen by using a control command received from an input unit. The renderer generates a screen of various layouts including objects based on the attribute values calculated by the operator. The screen generated by the renderer is displayed in a display area of a display 150.

A microphone 130 receives a voice from a user. For example, the microphone 130 may be buried in the electronic apparatus 100 or may be installed at an end of an extension line extending from the electronic apparatus 100.

A camera 140 captures an image of the user. The camera 140 may have a zoom function to clearly capture face feature points of the user.

A display 150 displays various types of screens. For example, a screen may include an application execution screen including various types of objects, such as an image, a moving image, a text, etc., a GUI screen, etc.

The display 150 may be realized as a liquid crystal display (LCD), an organic light-emitting diode (OLED), or the like.

A communicator 160 is an element including, for example, communication circuitry that performs communications with various types of external devices according to various types of communication methods.

For example, the communicator 160 performs a function of transmitting a user captured image, voice data, conversation feature information generated by the processor 120, etc. to an external device or receiving a user captured image, voice data, etc. from the external device. Therefore, the communicator 160 may include various types of communication chips such as a WiFi chip (not shown), a Bluetooth chip (not shown), a wireless communication chip (not shown), etc.

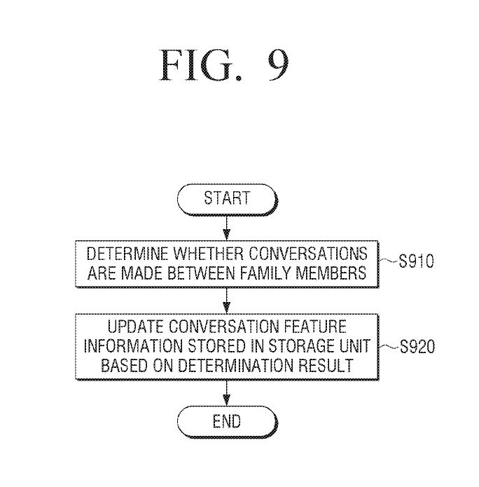

FIG. 9 is a flowchart illustrating an example method of processing information of the electronic apparatus 100, according to an example embodiment.

Referring to FIG. 9, in operation 5910, a determination is made as to whether conversations are made between family members, based on at least one of a captured image of a user acquired by capturing a user image and a user voice. In operation 5920, feature information stored in the storage unit 110 is updated based on the determination result.

For example, the information processing method may further include acquiring respective images and voices of family members to generate family member information and registering the family member information in a storage unit, and if at least one of a captured image and a user voice is input, comparing the at least one of the captured image and the user voice to determine whether conversations are made between the family members.

The information processing method may further include family member information based on an input pattern of a captured image and a user voice and registering the family member information, and if at least one of the captured image and the user voice is input, comparing the at least one of the captured image and the user voice with the family member information to determine whether conversations are made between family members. The input pattern may include at least one selected from an input time zone, an input cycle, and an input frequency where the captured image and the user voice are respectively input.

The information processing method may further include, if a preset event occurs, controlling a display to display updated conversation feature information.

The information processing method may further include, if a preset event occurs, transmitting the updated conversation feature information to a display apparatus through an interface.

The information processing method may further include, if a name of at least one of family members is detected from a user voice, determining that conversations are made between the family members.

For example, the conversation feature information may include a conversation time, and the information processing method may further include, if it is determined that conversations are made between family members, adding a time from a conversation start time to a conversation end time to an existing conversation time to update the conversation time.

The conversation feature information may include at least one selected from a conversation time, a current condition of one of family members taking part in conversations, a conversation subject, a time zone where conversations are made, and a conversation cycle.

Methods according to the above-described various example embodiments may be generated as software to be installed in the electronic apparatus 100.

For example, according to an example embodiment, there may be installed a non-transitory computer readable medium that stores a program performing determining whether conversations are made between family members, based on at least one of a captured image acquired by capturing a user and a user voice and updating feature information stored in a storage unit based on the determination result.

The non-transitory computer readable medium may, for example, store data semi-permanently and is readable by devices. For example, the aforementioned applications or programs may be stored in the non-transitory computer readable media such as compact disks (CDs), digital video disks (DVDs), hard disks, Blu-ray disks, universal serial buses (USBs), memory cards, and read-only memory (ROM).

The foregoing example embodiments and advantages are merely examples and are not to be construed as limiting the disclosure. The present teaching can be readily applied to other types of apparatuses. Also, the description of the example embodiments is intended to be illustrative, and not to limit the scope of the claims, and many alternatives, modifications, and variations will be apparent to those skilled in the art.

What is claimed is:

1. An electronic apparatus comprising:
a storage configured to store conversation feature information, said conversation feature information including conversation feature information of family members; and
a processor configured to determine whether conversations are made, based on at least one of a captured image acquired by capturing an image of a user and a user voice, and to update the conversation feature information stored in the storage based on the determination result.

2. The electronic apparatus of claim 1, wherein the processor is configured to acquire respective images and voices of the family members to generate family member information, to register the family member information in the storage, and, in response to at least one of the captured image and the user voice being input, to compare the at least one of the captured image and the user voice with the family member information to determine whether the conversations are made between the family members.

3. The electronic apparatus of claim 1, wherein the processor is configured to generate family member information based on an input pattern of the captured image and the user voice, to register the family member information in the storage, and, in response to at least one of the captured image and the user voice being input, to compare the at least one of the captured image and the user voice with the family member information to determine whether the conversations are made between the family members,
wherein the input pattern comprises at least one selected from: an input time zone, an input cycle, and an input frequency where the captured image and the user voice are input.

4. The electronic apparatus of claim 1, further comprising a display,
wherein in response to a preset event occurring, the processor is configured to control the display to display the updated conversation feature information.

5. The electronic apparatus of claim 1, further comprising:
an interface comprising interface circuitry, the interface configured to be connected to a display apparatus, and
wherein in response to a preset event occurring, the processor is configured to transmit the updated conversation feature information to the display apparatus through the interface.

6. The electronic apparatus of claim 1, wherein in response to a name of at least one of family members taking part in conversations being detected from the user voice, the processor is configured to determine that the conversations are made between the family members.

7. The electronic apparatus of claim 1, wherein the conversation feature information comprises a conversation time, and
wherein in response to a determination being made that the conversations are made between the family members, the processor is configured to add a time from a conversation start time to a conversation end time to an existing conversation time to update the conversation time.

8. The electronic apparatus of claim 1, wherein the conversation feature information comprises at least one selected from: a conversation time, a current condition of one of the family members taking part in conversations, a conversation subject, a time zone where the conversations are made, and a conversation cycle.

9. The electronic apparatus of claim 1, further comprising:
a camera configured to capture an image of the user to provide the captured image; and
a microphone configured to receive the user voice.

10. A method of processing information of an electronic apparatus, comprising:
capturing an image of a user;
capturing a user voice;
determining whether conversations are made between family members, based on at least one of the captured image and the user voice; and
updating conversation feature information stored in a storage based on the determination result.

11. The method of claim 10, further comprising:
acquiring respective images and voices of the family members to generate family member information and registering the family member information in the storage; and
in response to at least one of the captured image and the user voice being input, comparing the at least one of the captured image and the user voice with the family member information to determine whether conversations are made between the family members.

12. The method of claim 10, further comprising:
generating family member information based on an input pattern of the captured image and the user voice and registering the family member information in the storage; and
in response to at least one of the captured image and the user voice being input, comparing the at least one of the captured image and the user voice with the family member information to determine whether the conversations are made between the family members,
wherein the input pattern comprises at least one selected from: an input time zone, an input cycle, and an input frequency where the captured image and the user voice are input.

13. The method of claim 10, further comprising:
in response to a preset event occurring, controlling a display to display the updated conversation feature information.

14. The method of claim 10, further comprising:
in response to a preset event occurring, transmitting the updated conversation feature information to a display apparatus through an interface.

15. The method of claim 10, further comprising:
in response to a name of at least one of the family members being detected from the user voice, determining that the conversations are made between the family members.

16. The method of claim 10, wherein the conversation feature information comprises a conversation time, and
wherein the method further comprises, in response to a determination being made that the conversations are made between the family members, adding a time from a conversation start time to a conversation end time to an existing conversation time to update the conversation time.

17. The method of claim 10, wherein the conversation feature information comprises at least one selected from: a conversation time, a current condition of one of the family members taking part in conversations, a conversation subject, a time zone where the conversations are made, and a conversation cycle.
